(19) United States
(12) Patent Application Publication
(10) Pub. No.: US 2025/0087195 A1
(43) Pub. Date: Mar. 13, 2025

(54) Musical Instrument

(71) Applicant: Francisco Ruiz, Chicago, IL (US)

(72) Inventor: Francisco Ruiz, Chicago, IL (US)

(21) Appl. No.: 18/882,703

(22) Filed: Sep. 11, 2024

Related U.S. Application Data
(60) Provisional application No. 63/581,961, filed on Sep. 11, 2023.

(51) Int. Cl. G10K 5/00

(52) U.S. Cl. CPC G10K 5/00

(57) ABSTRACT

A musical instrument is disclosed. The musical instrument comprises a tubular body comprising a first mouthpiece and a bell for blowing air in and out of the tubular body. The musical instrument further comprises an orifice between the first mouthpiece and the bell. The orifice has a continuously curved longitudinal profile gradually opening up to an inlet side of the orifice from one of said first mouthpiece and the bell and to an outlet side of the orifice from one of the first mouthpiece and the bell. The musical instrument is adapted to be positioned between lips for blowing air.

### FIELD

The field is related to a musical instrument. Particularly, the field may relate to a musical instrument adapted to be positioned between lips for blowing air.

### BACKGROUND

The majority of humans learn to whistle with puckered lips at an early age. They learn to play simple tunes to amuse themselves, and some eventually become virtuosos who sound like a flute or similar instrument. Again, many others may never manage to learn despite their efforts. Many people strive to learn to whistle but remain unsuccessful. One important factor includes the shape of their lips which may be too different from the shape necessary to produce the sound, so they cannot manage to make an acceptable whistling sound no matter how hard they contort their lips. But if that shape were provided by artificial means they may be able to learn to whistle, avoiding a debilitating condition, and perhaps become virtuosos capable of playing beautiful music.

Even those who have learned how to whistle can benefit from an instrument that relieves them from the sustained effort to make an uncomfortable shape with their lips, which can lead to fatigue and even harm. They may also want to play louder than their natural lips allow, or for a longer time.

This is particularly true for people who may be playing another instrument simultaneously, such as a guitar or a piano, which requires the use of both hands.

Finally, there are a number of individuals who are impaired in the use of their hands and nonetheless would like to play music. They would need some instrument which only requires the mouth to play and produce sound or music.

There are several well-known methods to make a musical sound by means of a gaseous stream, typically air. In essence, the instruments deriving from these methods can be divided into two kinds: instruments where the air stream causes a solid reed or membrane to vibrate, which might be the player's own lips, and instruments where it is the air itself that vibrates without any part of the instrument itself vibrating. To the first method belong clarinets, trumpets and accordions, while to the second kind belong flutes, recorders, and organs. In order to play music, it is important for the pitch or frequency of the sound produced to be controllable, which is typically achieved by varying the length of an air column. This can be done by varying the full length, as in a trombone or an organ pipe, or the effective length up to a hole in a tube, as in a flute or recorder. Instruments based on the vibrating-reed method can also control the pitch by varying the weight or stiffness of the vibrating body, as in a harmonica or a cornet.

There are also devices that make sound by means of an air or steam flow but where pitch variation is not necessary and, in many cases, is impossible, as in a referee's whistle or a kettle whistle. These wind-driven instruments are called whistles.

U.S. Pat. No. 3,487,741 shows a typical whistle or recorder where the length of the air chamber, and therefore the emitted pitch, is varied by means of a piston. But this method requires the use of at least one hand in order to control the pitch. The sound-producing feature is a sharp edge, called a labium, where a fipple directs an air stream so part of it enters the air chamber, resulting in an oscillation where the air jet alternatively enters the air chamber or remains almost entirely outside it.

U.S. Pat. No. 1,228,532 describes a minimal instrument without tubes or air chambers, but it is designed to be played by blowing through the nose.

Australian Patent 2010271713B2, discloses a nose flute with the fipple and labium, and there is a plate to seal the instrument against the player's mouth.

U.S. Pat. No. 2,570,816 describes a wind instrument, held between the player's lips, and containing a vibrating reed, which is what makes the sound. This instrument relies upon the reed to produce the sound.

It should be noted that scientists have made little progress explaining the physics of human whistling. The best research so far is that of Wilson et al., Experiments on the Fluid Mechanics of Whistling, J. Acoust. Soc. Am. 50, 366-372 (1971). They studied circular orifices having a curved profile front-to-back that were able to whistle within a relatively narrow range of flow velocities, whereas all other researchers had studied sharp-edged, or at best beveled, orifices. They found that the pitch was primarily controlled by the volume of the space upstream of the orifice (representing the player's mouth), following the classic theory of acoustic resonance proposed by Helmholtz in the XIX century, but did not reach the point of producing a practically useful device. All their tests were performed with orifices that were too large for a human to be able to blow through them sustainably. There have been several subsequent investigations focused on the effect of the oral cavity that have confirmed this conclusion, but none that tried to find how a curved-profile orifice can produce the sound or attempted to optimize it.

Accordingly, there is a need for an alternate musical instrument addressing one or more of the previously mentioned limitations.

### SUMMARY

An embodiment of the present disclosure is a musical instrument, comprising a tubular body comprising a first mouthpiece and a bell for blowing air in and out of the tubular body, an orifice between the first mouthpiece and the bell, the orifice having a continuously curved longitudinal profile gradually opening up toward the mouthpiece and/or toward said bell. The musical instrument may be played by blowing or drawing air through it.

### BRIEF DESCRIPTION OF THE DRAWINGS

FIG. 1 shows a three-dimensional view of the musical instrument of the present disclosure.

FIGS. 2A, 2B, and 2C show three views of the musical instrument of the present disclosure, comprising a specially shaped orifice that makes a sound when air is blown through it in either direction.

FIG. 3 is a longitudinal section of the orifice showing the working of the musical instrument when air blows out.

FIG. 4 is another embodiment of the musical instrument shown in FIG. 3 when the air is drawn out of it.

FIG. 5 is a longitudinal section view of the musical instrument showing the curvature of the orifice profile, with circular case at top half and an elliptic case at bottom half.

FIGS. 6A, 6B, and 6C show three views of the musical instrument for the case where the hole has a circular rather than oblong cross-section.

FIGS. 7A, 7B, and 7C show three views of the musical instrument with asymmetric front-and-back.

FIGS. 8A, 8B, and 8C show three views of the musical instrument with a guard on one end.

FIGS. 9A, 9B, and 9C show three views of the musical instrument made from an edible material.

FIGS. 10A and 10B show two views of the musical instrument made of a flexible material and its functioning.

FIGS. 11A, 11B and 11C show three views of the musical instrument with multiple orifices.

### DETAILED DESCRIPTION

A musical instrument is disclosed. The musical instrument is adapted to be positioned between lips for blowing air. The musical instrument can be characterized as a hand-free musical instrument for producing sound or music and varying the pitch of the sound once the musical instrument is positioned between the lips. The musical instrument of the present disclosure allows a person to play a melody that can be controlled through breath and tongue position alone, so the hands can play an accompaniment. The musical instrument of the present disclosure can be a perfect instrument for a person having some form of disability in functioning of the hand since it only requires the mouth to control the sound and music. Unlike other wind instruments such as flute, clarinet, or trumpet, it is not necessary to stop for breath while playing the music instrument because it can be played both by blowing in or by drawing air through it, like an accordion.

The musical instrument of the present disclosure can be alternatively termed as a whistle because the player can easily control its pitch in operation and thus play harmonious music with it. Unlike other musical instruments based on wind, however, the musical instrument of the present disclosure does not involve any parts to contain a resonating air space, and sound production is achieved by means of different physics from those of apparently similar instruments. The physics of the musical instrument described herein can be the same as a human “pucker” whistling.

Almost all wind instruments without a vibrating body and almost all whistles make the sound by means of a sharp labium. The musical instrument of the present disclosure, however, does not have a sharp edge to divide the flow, but rather the entire flow courses unobstructed, around a curved surface with no edges in the flow path. This produces sound by means of an entirely different principle as described later in detail. The musical instrument of the present disclosure does not need any vibrating reed for producing sound. The disclosed musical instrument produces sound by careful design of the air path, without requiring any vibrating components.

Further, the musical instrument of the present disclosure works by blowing entirely through the player's mouth without involving the nose. The musical instrument of the present disclosure does not need a fipple or labium for producing the sound because the sound is made by different physics related to the characteristics and design of the instrument as described later in detail.

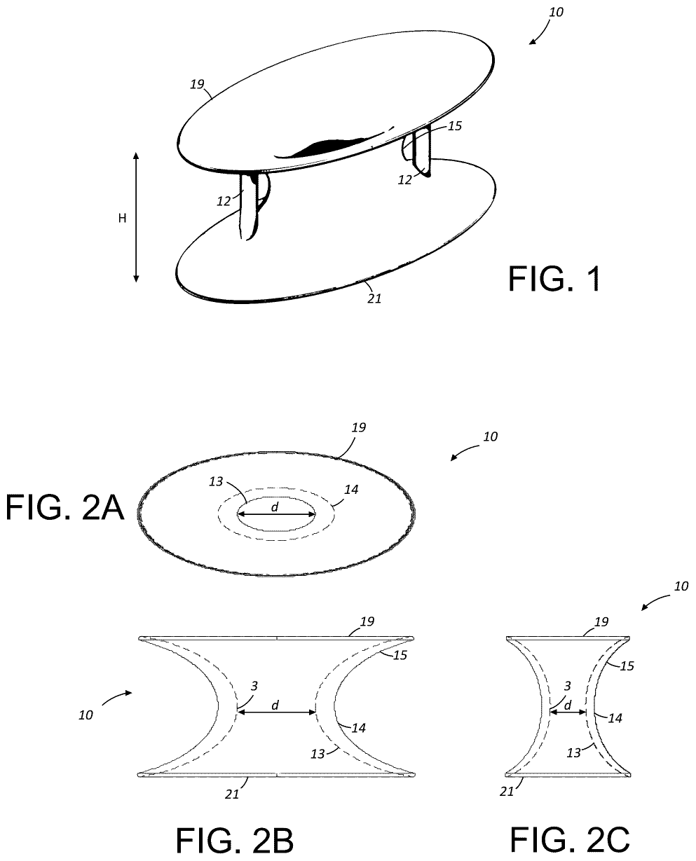

Referring to the Figures, FIG. 1 illustrates a three-dimensional view of the musical instrument 10. As shown, the musical instrument 10 has a tubular body comprising a mouthpiece 11 and a bell 21. The musical instrument 10 comprises an orifice 15 through which the air is blown. The orifice is unobstructed from mouthpiece 11 to bell 21. Also, one or more handles such as loops and hooks 12 can be disposed on an outer surface of the musical instrument 10 for holding or attaching string, a chain or a thread to the musical instrument 10. The musical instrument 10 may be characterized by a height H. In an exemplary embodiment, the height H of musical instrument 10 may be from about 10 mm to about 25 mm.

Three orthogonal views 2A, 2B, and 2C of the musical instrument 10 are shown in FIG. 2. A top plan view is shown in FIG. 2A, and a side elevational view is shown in FIGS. 2B and 2C of the musical instrument 10. 2. The top view in FIG. 2A depicts the mouthpiece 19. The orifice 15 is defined by a wall 14 that has an unobstructed inner surface 13 as shown in the top view 1. By unobstructed is meant nothing in the orifice 15 will obstruct air flow. Also, the orifice 15 has a throat 3 which can be characterized by the narrowest cross section of the orifice. The top view in FIG. 2A shows the throat 3 is characterized by a diameter d. The orthogonal view in FIGS. 2B and 2C show the mouthpiece 19 and the bell 21 and the unobstructed orifice 15. The orifice 15 is defined by the inner surface 13 of the wall 14. The inner surface 13 of the orifice 15 has a longitudinal profile is continuously curved. By continuously curved is meant, the longitudinal profile defines a curve that is not interrupted by a surface with a greater slope or a significantly greater slope preferably between the throat 3 and the mouthpiece 19 and/or the bell 21. The slope referenced is preferably an inward slope. Moreover, the longitudinal projection of the throat 3 is free from obstruction from mouthpiece 19 to bell 21. The orifice 3 may open outwardly toward the mouthpiece 19. The orifice 3 may open outwardly toward the bell 21. The diameter of the orifice 3 gradually increases from the throat in the inside of the orifice toward the mouthpiece 19. Conjunctively or alternatively, the diameter of the orifice gradually increases from the throat 3 in the inside of the orifice toward the bell 21. The thickness of the 14 wall is gradually increasing from mouthpiece 19 and is at a maximum near the throat 3 of the orifice 15. Similarly, the thickness of the orifice wall 14 is gradually increasing from the bell 21 and reaches the maximum thickness near the throat 3 of the orifice 15. Air can be blown from any of the two mouthpieces 19 and 21 into the orifice 15. The orifice can have a hyperbolic longitudinal cross section.

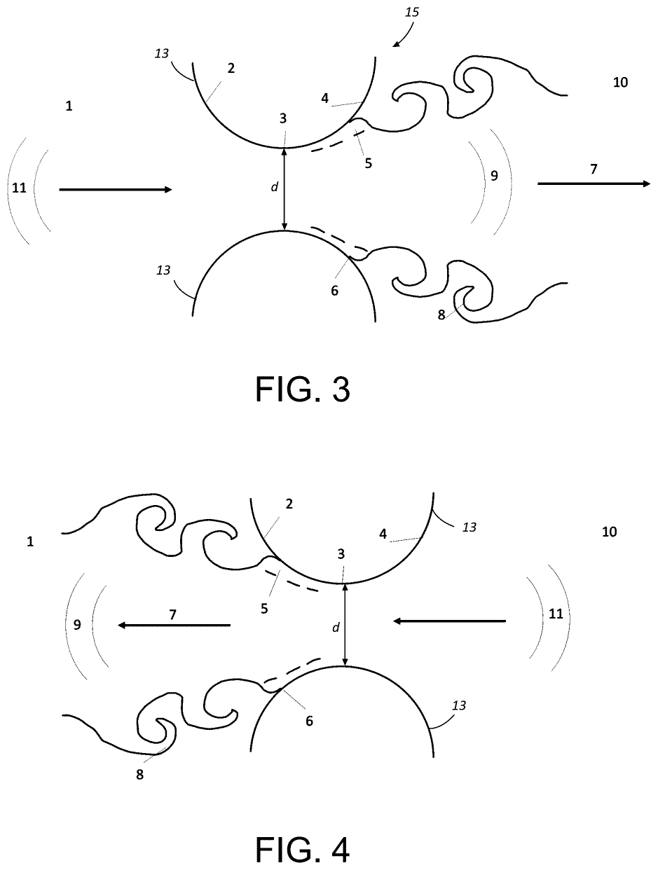

FIG. 3 shows a longitudinal section of the orifice 15 depicting the working of the musical instrument 10 when a player blows air through the orifice 15. In the exemplary embodiment as shown in FIG. 3, the player is blowing air from the mouthpiece 19, so that the air after passing through the orifice 15 comes out of the bell 21 which serves as a bell. The musical instrument 10 is positioned near the lips (not shown) of the player in a way to hold the musical instrument 10 between the lips. Oral cavity or mouth 1 represents an inside of the player's mouth facing the mouthpiece 19. The player blows the air from the oral cavity 1 from the mouthpiece 19 into the orifice 15. Air converges from the oral cavity 1 into the orifice 15 in a smooth fashion because of the inwardly converging side 2 of the inner surface 13. When the air reaches the narrowest point which is the throat 3 of the orifice 15, the velocity profile of the air is almost uniform and there is hardly any turbulence. As the air proceeds out from the orifice 15 through a diverging side 4 of the inner surface 13 of the orifice 15, its velocity drops in a manner inversely proportional to the orifice's cross-sectional area because the Mach number is low. The cross-sectional area is proportional to the square of the local inner diameter of the orifice 15. This drop in velocity of the air also causes an increase in pressure proportional to the change in the square of the velocity. As air gradually comes out, it starts forming a boundary layer 5 on the inner surface 13 while coming out. The velocity of the air within the boundary layer 5 adjacent to the orifice inner surface 13 drops faster, however, and at some point such as point 6 the air reverses direction, causing the flow to separate from the inner surface 13 and form a air jet 7 detached from the orifice 15. The flow of the air now becomes narrower and faster, the pressure drops, and a ring-shaped vortex 8 is formed between the air jet and the orifice inner surface 13. This vortex is carried downstream, dragged by the air jet 7. The sudden change in the velocity and pressure of the air creates a pressure wave 9 that travels both towards the outside environment 10, where it is perceived as sound, and toward the player's mouth 1. The pressure wave inside the player's mouth 1 reaches the constriction at the back 11 of the mouth, where it reflects. After a period of time that is proportional to the square root of the oral cavity volume of the mouth 1, the reflected pressure wave reaches the musical instrument 10 and supplies enough energy for the flow to re-attach to the wall 13, releasing the vortex 8 and preparing the musical instrument 10 for the next cycle. The result is a chain of ring vortices 8 spaced by regular intervals, plus a periodic variation of pressure that is perceived as a pure sound. The pitch depends on the roundtrip time of the pressure wave inside the player's mouth 1, so that it is higher pitched relative to the closeness of the tongue to the instrument, thus making a smaller oral volume.

FIG. 4 shows another exemplary embodiment of FIG. 3 when a player draws air through the orifice 15. In the exemplary embodiment as shown in FIG. 4, the player is drawing air from the bell 21 so that the air after passing through the orifice 15 comes out of the mouthpiece 19. The functioning of the musical instrument is same as described above in FIG. 3. In this embodiment, the chain of the ring vortices 8 is formed inside the player's mouth 1. The pressure wave 9 that is reflected at the back of the player's mouth 1 and ends up releasing the vortex 8 is still the one that travels into the player's mouth, while the one that travels outward, labeled 10 in the FIG. 3, still produces the sound of the musical instrument 10.

The sound results from a delicate interplay between the tendency of the air jet 7 to attach to or detach from the diverging side 4 and the pressure waves 9 and 10, which cause the air jet 7 to change velocity, which in turn affects its tendency to attach or detach to the wall 13.

Applicants found though experimentation that only certain values of wall profile curvature, orifice diameter, and jet velocity lead to successful sound production. It is found after several experiments, aided by computer modeling, of many high-resolution 3D-printed models. Departing too far from the optimum values disclosed here may affect the functioning of the musical instrument to produce a pleasant sound, require an excessive amount of air, or be hard to control.

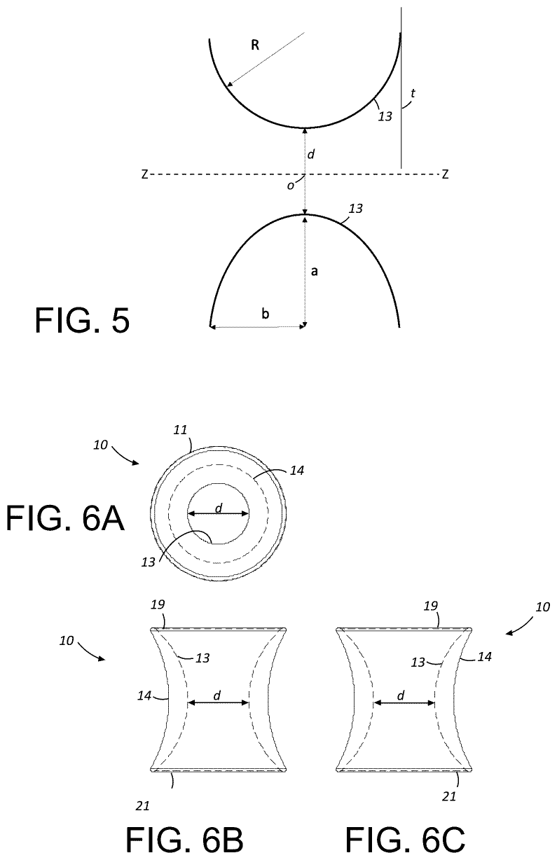

FIG. 5 shows a geometry of the orifice 15 on a longitudinal section of the orifice 15. In the exemplary embodiment as shown in FIG. 5, the inner surface 13 of the orifice 15 is axisymmetric along an imaginary axis ZZ passing through a center O of the orifice. The orifice surface as shown in FIG. 5 can be characterized as an inside of a toroid. In an exemplary embodiment, the orifice 15 is characterized by an inner diameter d of about 4 mm to about 8 mm. In an aspect, the orifice 15 has an inner diameter d which is no smaller than about 2.5 mm, preferably no smaller than 3 mm. For a smaller diameter orifice, the boundary layer 5 shown in FIG. 3 may become too thick relative to the main flow of the air and which may lead to the volume of the sound produced being too low. The larger the inner diameter d, the higher the volume and also the larger the air flow. A large diameter d requires a large air flow that is hard to maintain even for an adult player. Applicant observed that a diameter d greater than about 8 mm, or about 6 mm may require a large air flow that is hard to maintain even for an adult player.

The longitudinal profile of the orifice 15 has a radius of curvature R that needs to be within a specific range so the air flow can attach to the wall 13 and form the boundary layer 5. Applicant found that the radius of curvature R of the orifice 15 should be at least about 4 mm for the flow to attach the wall 14. Also, applicant observed that at a larger radius of curvature R, the musical instrument 10 starts getting progressively noisy. In an exemplary embodiment, the longitudinal profile of the orifice 15 is characterized by a radius of curvature R from about 4 mm to about 9 mm.

In an aspect, the orifice 15 has a curved inner surface 13. Applicant observed that the musical instrument 10 functions properly when the curved inner surface 13 extends until its tangent t is perpendicular to the longitudinal axis ZZ, but it can be a little shorter without much loss of performance, as long as it is at least 5 mm tall above the throat 3. The distance b from the narrowest point which the throat 3 of the orifice 15 to the point where the curved inner surface 13 ends at the mouthpieces 19 and 21 should be at least about 5 mm, suitably at least about 6 mm, more suitably at least about 7 mm or preferably at least about 8 mm so the outgoing flow can reattach completely. Applicants observed that a minimum of about 7 mm or about 6 mm or about 5 mm is necessary in order to obtain a laminar flow at the throat 3.

In an aspect, the inner wall surface of the orifice 15 may include a different curved longitudinal profile rather than circular, as shown in the lower part 20 of FIG. 5 below axis ZZ. The elliptical profile may be characterized by a first semi-axis a and a second semi-axis b perpendicular to the first semi-axis a. The first semi-axis a can be a major axis and the second semi-axis b can be a minor axis. In elliptical profile of the lower part 20 of orifice 15, the musical instrument functions properly when the curvature diminishes from the narrowest section which is the throat 3 to the outside near the mouthpieces 19 and 21. Such a curvature for elliptical profile helps the boundary layer 5 (FIG. 3) to remain attached to the inner surface 13 for a longer distance, and therefore create larger and more energetic vortices 8 (FIG. 3). A good optimum is a toroidal orifice where the generator profile is an ellipse with minor diameter of less than about 16 mm, parallel to the orifice axis ZZ, and a major diameter of less than about 30 mm. In an exemplary embodiment, the first semi-axis a is about 7 mm to about 15 mm at the orifice throat 3, and the second semi-axis b is about 4 mm to about 8 mm in the direction perpendicular to it.

The musical instrument 10 may be characterized by a curved cross-section which is perpendicular to the direction of the air flow. The musical instrument 10 may have a cross section selected from circular, elliptical, oblong, obround, toroid, or a different curved or curved shape. FIGS. 6A, 6B and 6C show the musical instrument 10 with a circular cross section. Three orthogonal views in FIGS. 6A, 6B and 6C of the musical instrument 10 are shown. The plan view in FIG. 6A depicts the circular cross section of the musical instrument 10. Side elevational views of the musical instrument 10 are shown in FIGS. 6B and 6C. Applicants observed that the elliptical cross-section as shown in FIGS. 2A-C may provide a better range, where both high and low notes can be reached more easily. Non-curved cross-sections may affect the clean-sounding functioning of the musical instrument 10.

In an exemplary embodiment, the first mouthpiece 19 and the bell 21 may be symmetrical to each other. In another exemplary embodiment, the first mouthpiece 19 and the bell 21 may be asymmetrical to each other.

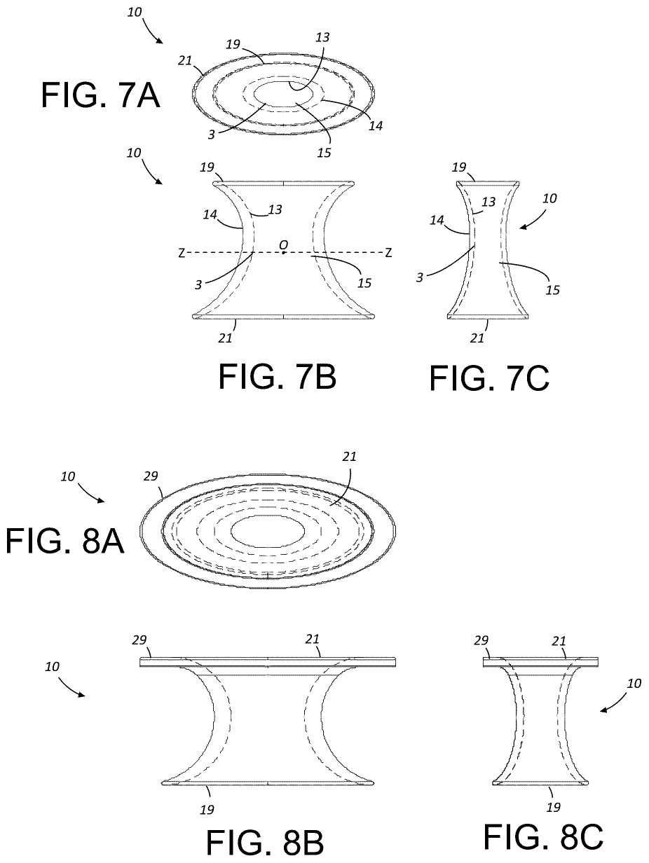

FIGS. 7A, 7B, and 7C show another exemplary embodiment of the musical instrument 10. In this embodiment, the first mouthpiece 19 and the bell 21 are asymmetrical to each other. FIG. 7A depicts a top plan view of the musical instrument 10 in which the mouthpiece 19 has a smaller diameter as compared to the bell 21. Side elevational views of the musical instrument 10 are shown in FIGS. 7B and 7C.

The larger cross-section of the orifice 15, the louder the sound it will produce, but this also requires more air. Applicant found that best results can be obtained with a cross-sectional area at the narrowest point, at the throat 3 of above about 10 mm² or slightly larger, for an adult. This may need to be reduced for use by children, at the expense of less loudness. In an exemplary embodiment, the orifice 15 is characterized by a throat 3 having a cross-sectional area from about 6 mm² to about 25 mm² and preferably from about 8 mm² to about 20 mm².

The inside surface 13 of the orifice 15 must be as smooth as possible so the flow is laminar at the throat 3 and reattachment occurs smoothly. Imperfections of the inside surface 13 of the wall 14 must be kept to a minimum. For instance, longitudinal furrows or ridges in the direction of the flow degrade the performance only slightly, but transversal furrows or ridges, even if barely visible to the naked eye, lead to severely degraded performance because they disrupt the boundary layer 5 (FIG. 3). This must be considered when manufacturing the instrument by a process that might leave burrs on the inner surface.

The musical instrument 10 of the present disclosure has small dimensions such as that shown in FIG. 1, a player might accidentally swallow it. Though the danger of asphyxiation is mitigated by the fact that the musical instrument has a hole in the middle as shown in the Figures, through which air can still flow even in the instrument its lodged in the player's windpipe, this danger can be further reduced by adding an expanded flat section 29 such as a plate on the bell 21 of the musical instrument 10, around the orifice 15, to make it hard to swallow, as shown in FIGS. 8A-8C.Three orthogonal views in FIGS. 8A, 8B, and 8C of the musical instrument 10 are shown. The elevational views of FIGS. 8B and 8C are inverted relative to the other elevation views. A top view 8A of the musical instrument 10 depicts the expanded section 29 on the outer side of the mouthpiece 19. Side orthogonal views of the musical instrument 10 with the expanded section 29 are shown in FIG. 8B and 8C. The expanded flat section 29 which can be equally applied on the bell 21. Safety can also be enhanced if a string or chain is attached to the musical instrument to the handles 12 as shown in FIG. 1 or similar features on its outer surface to be able to pull it out even if it gets swallowed. Another safety feature is to round the edges of the mouthpieces 19 and 21 instrument so it cannot get caught easily within a person's windpipe.

Preferably, the musical instrument is made from an elastic and flexible material for producing sounds with variations. In an aspect, the musical instrument 10 can be made of an edible or otherwise biodegradable material so it does not lead to a permanent hazard, should it be swallowed accidentally. If made of an edible material in the form of a candy, it has the good property that the instrument will continue sounding normally as it dissolves from the outside in, since the working surfaces are all on the interior.

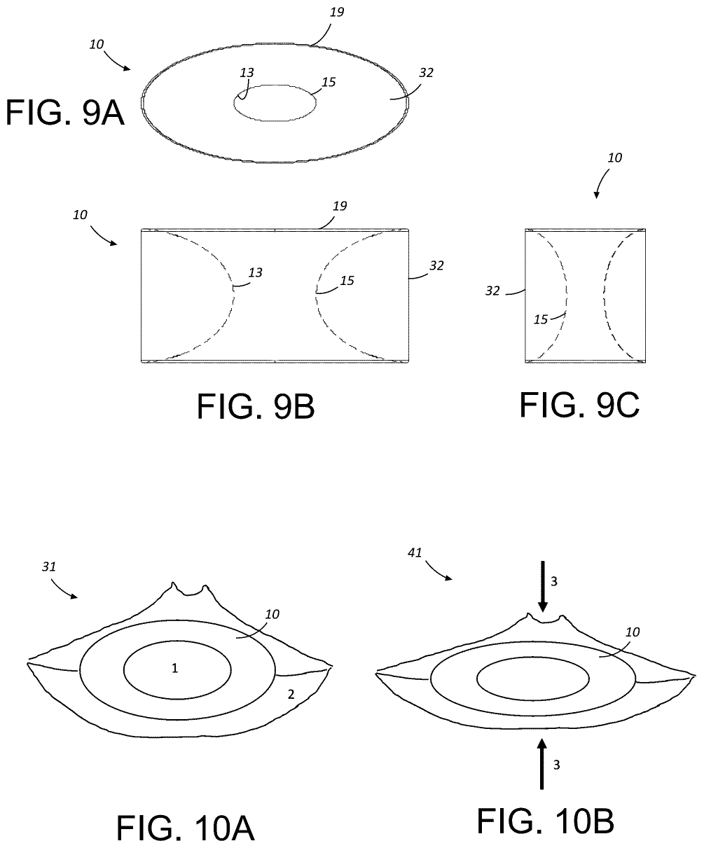

FIGS. 9A, 9B, and 9C show a musical instrument 10 that would produce sound on the surface if its inner wall 12, while its outer wall 14 is suitable to be made of candy 32. A top plan view in FIG. 9A of the musical instrument 10 depicts an outer layer of an edible material 32 which covers the orifice 15. Side elevational views of the musical instrument 10 with the outer layer of the edible material 32 are shown in FIGS. 9B and 9C.

The musical instrument 10 can be made either of a rigid material or of a soft elastic material that will deform as the player's lips press on it. Low notes are reached more easily when the cross-sectional area of the orifice is large, while high notes are reached better with a smaller cross-section of the orifice is 15. Using a flexible instrument, the player will be able to reach both high and low notes by expanding his/her lips for the low notes, and compressing them for the high notes, thus reducing the orifice cross-sectional area, as shown in FIGS. 10A and 10B.

FIG. 10A shows the normal position 31 of the musical instrument 10 when held with the lips 2. FIG. 10B show a compressed position 41 of the musical instrument 10 when compressed with the lips 2. As shown in the compressed position 41, the orifice 15 is compressed and narrowed when the player's lips 2 exert a force 3 on the top and the bottom of the musical instrument 10.

The musical instrument 10 of the present disclosure can be fabricated by injection molding, using a two-part mandrel for the hole, or by joining two halves as described above. Care must be exercised so there are no transversal burrs that would affect the flow of air, especially at the orifice throat 3. Orifices of circular cross-section can also be made by drilling, using a special bit shaped like the orifice wall from the middle outwards. Another way to make the musical instrument 10 may include 3D printing, but the resolution must be fine, or a smoothing process must be used afterwards. The wall 14 can be formed, for instance, by fusing together two half-pieces made by traditional rolling dies. This may create a seam on the inside surface 13 of the wall 14, but its effect on the sound will be small if the seam is longitudinal relative to the air flow.

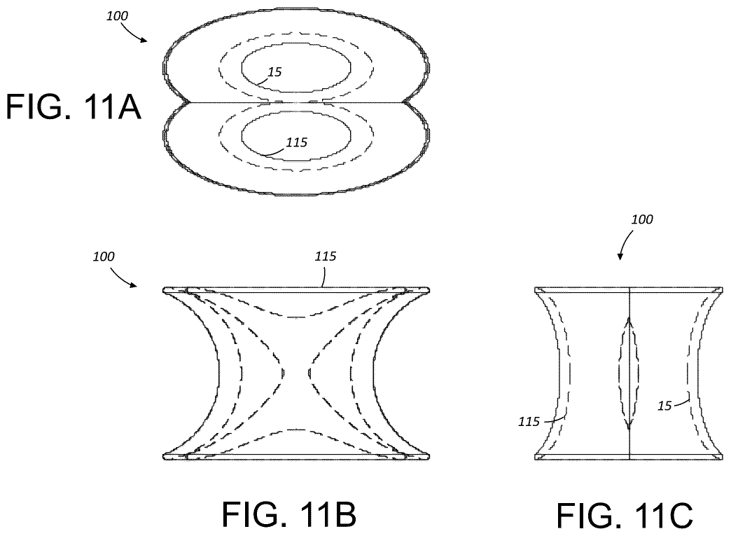

As shown in FIGS. 11A, 11B and 11C, the musical instrument 100 may comprise a plurality of orifices 15 and 115. In this case, it will produce a larger volume of sound at the expense of more air flow. All the orifices 15 and 115 will produce nearly the same pitch because this is primarily controlled by the position of the player's tongue. The orifices 15 and 115 may have similar or different diameter. If the holes are not exactly the same there will be small differences in frequency due to differences in hole size and flow rate, resulting in a beating or whirring sound, due to interference between sounds at slightly different pitches.

Disclosed is a musical instrument that a musician may play hands free while enhancing his own musical abilities.

1. A musical instrument, comprising:
a tubular body comprising a mouthpiece and a bell for blowing air in or out of the tubular body, an orifice between said mouthpiece and said bell, said orifice having a continuously curved longitudinal profile gradually opening toward said mouthpiece or toward said bell.

2. The musical instrument of claim 1, wherein the musical instrument is adapted to be positioned between lips for blowing air.

3. The musical instrument of claim 1, wherein air is blown in or out from any of said mouthpiece and said bell and through said orifice to produce sound.

4. The musical instrument of claim 1, wherein an inner diameter of said tubular body gradually increases toward said mouthpiece and toward said bell.

5. The musical instrument of claim 1, wherein said mouthpiece and said bell have a symmetrical shape.

6. The musical instrument of claim 1, wherein said mouthpiece and said bell have an asymmetrical shape.

7. The musical instrument of claim 1 further comprising an expanded section on an outside surface of said tubular body, the expanded section covering one or both of said first mouthpiece and said bell.

8. The musical instrument of claim 1 further comprising one or more loops and brackets on an outside surface of said tubular body and away from said first mouthpiece and said bell.

9. The musical instrument of claim 1, wherein the musical instrument comprises an elastic material.

10. The musical instrument of claim 1, wherein the musical instrument comprises an edible material.

11. The musical instrument of claim 1, wherein the orifice comprises a plurality of holes.

12. The musical instrument of claim 1, wherein the orifice is characterized by a throat having a cross-section area from about 6 mm² to about 25 mm².

13. The musical instrument of claim 1, wherein the curved longitudinal profile is characterized by a radius of curvature from about 4 mm to about 9 mm.

14. The musical instrument of claim 1, wherein said orifice has an oblong cross-section characterized by a major axis and a minor axis, the minor axis is about 40% to about 50% of the major axis.

15. The musical instrument of claim 1, wherein said curved longitudinal profile is an elliptical profile characterized by a first semi-axis and a second semi-axis perpendicular to the first semi-axis, and wherein the first semi-axis is about 7 mm to about 15 mm at an orifice throat, and the second semi-axis is about 4 mm to about 8 mm in the direction perpendicular to it.

16. The musical instrument of claim 1, wherein said musical instrument is a single piece instrument.

17. The musical instrument of claim 1, wherein said tubular body has a smooth inner surface to provide a continuous and undivided flow of air from one of said first mouthpiece and said bell through the orifice and to one of said first mouthpiece and said bell to produce a sound.

18. The musical instrument of claim 1, wherein said orifice is compressed with the lips to produce sound.

19. A musical instrument, comprising:
a tubular body comprising a mouthpiece and a bell for blowing air in or out of the tubular body, an orifice between said mouthpiece and said bell, said orifice having a continuously curved longitudinal profile of increasing inner diameter toward said mouthpiece and toward said bell.

20. A process for playing a musical instrument, comprising:
blowing air through a tubular body comprising a mouthpiece and a bell for blowing air in or out of the tubular body, an orifice between said mouthpiece and said bell, said orifice having a continuously curved longitudinal profile gradually opening toward said mouthpiece or toward said bell.
